(19) United States
(12) Patent Application Publication
(10) Pub. No.: US 2023/0334482 A1
(43) Pub. Date: Oct. 19, 2023

(54) Dynamic Quantum Enabled Method for Large Currency Transaction Exemption using Distributed Hash Chain

(71) Applicant: Bank of America Corporation, Charlotte, NC (US)

(72) Inventors: Sakshi Bakshi, New Delhi (IN); Siva Kumar Paini, Hyderabad, Telangana (IN); Virendra Kumar Sharma, New Delhi (IN); Ranjan Verma, Faridabad, Haryana (IN); Prashant Anna Bidkar, Dehli (IN)

(21) Appl. No.: 17/721,928

(22) Filed: Apr. 15, 2022

(51) Int. Cl. G06Q 20/38; G06N 10/60; G06N 10/20; G06N 10/80; H04L 9/00

(52) U.S. Cl. CPC G06Q 20/389; G06N 10/60; G06N 10/20; G06N 10/80; H04L 9/50; G06Q 2220/00; H04L 2209/56

(57) ABSTRACT

A system for determining transactions eligible for currency transaction report (CTR) exemption using a quantum computing algorithm is described. The system may further leverage a distributed computing architecture for manual review and filing of CTRs and/or approving a CTR exemption as determined by the quantum computing algorithm.

### FIELD

Aspects described herein generally relate to the application of quantum computing and distributed ledger systems for processing financial transactions.

### BACKGROUND

Banks and other financial institutions may be required to report certain transactions to regulatory authorities. In the United States, financial institutions are required to file currency transaction reports (CTRs) with a regulatory authority for all cash transactions, by clients, that exceed regulatory limits as defined by Bank Secrecy Act (BSA). For example, financial institutions are required to file CTRs for cash transactions by a client/entity that exceed $10,000 in a single business day. A CTR for a transaction may include identification information/account numbers of individuals/entities associated with the transaction, a value of the transaction, etc. Transactions may include any of deposits and withdrawals, automated teller machine (ATM) transactions, denomination exchanges, loan payments, currency transactions used to fund individual retirement accounts (IRAs), purchases of certificates of deposit, funds transfers paid for in currency, monetary instrument purchases, and/or the like.

As per BSA, financial institutions can exempt eligible businesses and entities from CTRs if they fulfil certain exemption criteria. Identifying businesses/entities to be recommended for exemptions along with final approval of exemption status, approving/revoking an exemption, is a manual process. Transactions that are processed by banking institutions for CTR filing may run into thousands or even millions per day. Manual processing may delay the identification & submission of businesses/entities for new request reviews and may involve human errors in approving/rejecting CTR exemption.

Meanwhile, advances in quantum computing technology have enabled exponential increases in speeds associated with processing certain types of data and/or performing certain types of computing operations. Distributed computing technology (e.g., distributed hash tables, hash chains, etc.) have reduced processing burden on specific computing nodes and improved overall data security.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of this disclosure provide effective, efficient, scalable, and convenient technical solutions that address various issues associated with exempting financial transactions from regulatory requirements. One or more aspects relate to use of a quantum computing-based algorithm for enabling parallel processing and search of a plurality of transactions, and a distributed hash chain network for approving and recording exemptions of prior transactions.

In accordance with one or more arrangements, a system for identifying and reporting financial transactions eligible for filing currency transaction reports (CTRs) is described. The system may comprise a plurality of computing nodes forming a peer-to-peer network storing a distributed hash table (DHT); and a quantum computing platform. The quantum computing platform may comprise at least one processor; and memory storing computer-readable instructions that, when executed by the at least one processor, cause the computing platform to perform one or more operations. The quantum computing platform may receive indications of a plurality of transactions, wherein each of the indications comprises a corresponding transaction identifier. The quantum computing platform may initialize a plurality of qubits for representing transaction identifiers associated with the plurality of transactions, and apply Hadamard gates to the plurality of qubits to generate a uniform superposition of states. Each state corresponding to the uniform superposition may have an identical probability of occurrence. Each state corresponding to the uniform superposition may represent a corresponding transaction identifier. The quantum computing platform may determine, using Grover's algorithm, one or more transaction identifiers of one or more transactions for which CTRs are to be filed. The determining the one or more transaction identifiers may be based on deviations of the one or more transactions from CTR exemption rules defined by a rule engine. The quantum computing platform may send, to the DHT, indications of the one or more transactions.

In some arrangements, the quantum computing platform may generate, based on the rules defined by the rule engine, a phase flip transaction scanner to flip phases of one or more states, corresponding to the one or more transaction identifiers, of the uniform superposition. The quantum computing platform may apply the phase flip transaction scanner to the uniform superposition to flip phases of the one or more states, corresponding to the one or more transaction identifiers, of the uniform superposition. The quantum computing platform may determine a reflection of amplitudes of the one or more states along a mean amplitude of the states. The quantum computing platform may measure the plurality of qubits to determine the one or more transaction identifiers corresponding to the one or more states.

In some arrangements, each transaction of the plurality of transactions may be associated with corresponding transaction information, wherein transaction information of a transaction may comprise one or more of: monetary value of the transaction; source account of the transaction; destination account of the transaction; geographical location of the transaction; or business category of an entity associated with the transaction. Sending, to the DHT, indications of the one or more transactions may comprise sending, to the DHT, the one or more transaction identifiers and transaction information of each of the one or more transactions.

In some arrangements, the rule engine may comprise one or more of: user-defined rules for CTR exemption; or ledger entries, from the DHT, indicating historical transactions for which CTR exemptions were previously approved.

In some arrangements, the deviations of the one or more transactions from the CTR exemption rules defined by the rule engine may comprise deviation of transaction information of the one or more transactions from the CTR exemption rules defined by the rule engine. The quantum computing platform may determine the one or more transaction identifiers based on determining that corresponding monetary values of the one or more transactions exceeds a threshold monetary value as indicated in the rule engine. The quantum computing platform may determine the one or more transaction identifiers based on determining that geographical locations associated with the one or more transactions is outside a geographical location as indicated in the rule engine.

In some arrangements, the quantum computing platform may send the indications of the one or more transactions to a subset of the plurality of computing nodes. In some arrangements, sending, to the DHT, the indications of the one or more transactions may comprise sending, to the DHT, the indications of the one or more transactions along with indications that the quantum computing platform recommends CTR filing for the one or more transactions.

In some arrangements, a transaction of the plurality of transactions may comprise: deposits, withdrawals, automated teller machine (ATM) transactions, denomination exchanges, or electronic fund transfers paid for in currency.

In accordance with one or more arrangements, a system for identifying and reporting financial transactions eligible for filing currency transaction reports (CTRs) is described. The system may comprise a quantum transaction analyzer configured to parallelly processing a plurality of transactions, using CTR exemption rules, to determine one or more transactions that are recommended to be exempt from CTR filing. The system may further comprise a distributed peer-to-peer network, comprising a plurality of computing nodes. A computing node, of the plurality of computing nodes, may receive, from the quantum transaction analyzer, indications of the one or more transactions and add, to a local hash chain associated with the computing node, the indications of the one or more transactions. The computing node may validate, using local CTR exemption rules associated with the computing node, at least one transaction, of the one or more transactions, as being exempt from CTR filing. The computing node may send, to a user computing device, a notification indicating the at least one transaction. The computing node may receive a user input indicating whether a CTR is to be filed for the at least one transaction. The computing node may update, based on the user input, the local hash chain to mark the at least one transaction for CTR filing or CTR exemption.

In some arrangements, the computing node may update the local hash chain to mark the at least one transaction for CTR filing or exemption by: adding an indication to the local hash chain marking the at least one transaction for deletion from the local hash chain if the user input indicates that a CTR is to be filed for the at least one transaction; or adding an indication to the local hash chain marking the at least one transaction as verified for CTR exemption if the user input indicates that the at least one transaction is to be exempted from CTR. The computing node may send, to a rules engine, transaction information associated with the at least one transaction if the user input indicates that the at least one transaction is to be exempted from CTR filing.

In some arrangements, the indications of the one or more transactions may comprise identifiers of the one or more transactions and transaction information of the one or more transactions. The transaction information of the one or more transactions may comprise one or more of: monetary values of the one or more transactions; source accounts of the one or more transaction; destination accounts of the one or more transactions; geographical locations of the one or more transactions; or business categories of entities associated with the one or more transactions, wherein the validating the at least one transaction is based on transaction information of the at least one transaction.

In some arrangements, the quantum transaction analyzer may receive indications of a plurality of transactions, wherein each of the indications comprise a corresponding transaction identifier. The quantum transaction analyzer may initialize a plurality of qubits for representing transaction identifiers associated with the plurality of transactions, and apply Hadamard gates to the plurality of qubits to generate a uniform superposition of states. Each state corresponding to the uniform superposition may have an identical probability of occurrence. Each state corresponding to the uniform superposition may represent a corresponding transaction identifier. The quantum transaction analyzer may determine, using Grover's algorithm, transaction identifiers of a subset, of the plurality of transactions, for which CTRs are to be filed. The determining the transaction identifiers may be based on deviations of the subset from CTR exemption rules defined by a rule engine. The quantum transaction analyzer may send, to the computing node, indications of the one or more transactions, wherein the one or more transactions may not comprise any transactions in the subset. The sending, to the computing node, nay be based on determining that the one or more transactions correspond to a transaction type associated with the computing node.

In some arrangements, the quantum transaction analyzer may generate, based on the rules defined by the rule engine, a phase flip transaction scanner to flip phases of states corresponding to the transaction identifiers of the subset. The determining the transaction identifiers of the subset may comprise: applying the phase flip transaction scanner to the uniform superposition to flip the phases of the states corresponding to the transaction identifiers of the subset; determining a reflection of amplitudes of the states, corresponding to the transaction identifiers of the subset, along a mean amplitude of all states of the uniform superposition; and measuring the plurality of qubits to determine the transaction identifiers of the subset.

In some arrangements, the quantum transaction analyzer may determine the subset based on transaction information of transactions in the subset not conforming to CTR exemption rules defined by the rule engine. The quantum transaction analyzer may send, to the computing node, the indications of the one or more transactions along with indications that the quantum transaction analyzer recommends CTR exemption for the one or more transactions.

In some arrangements, a transaction of the one or more transactions may comprise: deposits, withdrawals, automated teller machine (ATM) transactions, denomination exchanges, or electronic fund transfers paid for in currency.

### BRIEF DESCRIPTION OF THE DRAWINGS

The present disclosure is illustrated by way of example and not limited in the accompanying figures in which like reference numerals indicate similar elements and in which:

FIG. 1 shows an example architecture for a system to determine and process a CTR exemption for a transaction, in accordance with one or more example arrangements;

FIG. 2 shows an example algorithm at a quantum transaction analyzer for determining whether or not a transaction is exempted from CTR filing, in accordance with one or more example arrangements;

FIG. 3 shows an example algorithm at a computing node for processing a transaction as received from a quantum transaction analyzer, in accordance with one or more example arrangements;

FIG. 4 shows an example operation of a peer-to-peer (P2P) network for transaction verification at a computing node, in accordance with one or more example arrangements;

FIG. 5A shows an illustrative computing environment for implementing a system for CTR exemption processing, in accordance with one or more arrangements;

FIG. 5B shows an example quantum transaction analyzer, in accordance with one or more example arrangements; and

FIG. 5C shows an example enterprise application host platform, in accordance with one or more arrangements.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Exemptions for CTR filing may be based on multiple criteria. For example, exemption of a client of a financial institution may be based on criteria defined by a regulatory authority. A client may be exempt if the financial institution has previously performed diligence for the client and manually approved an exemption. Transactions associated with certain types of clients (e.g., banking/financial institutions, federal/state governmental bodies, entities listed in national stock exchanges) may also be exempt. Clients performing transactions that exceed a threshold quantity of transactions in a predefined time period, and whose previous transactions were determined to be exempt, may be exempt from CTR filing for future transactions. Transactions of clients based outside certain geographical areas (e.g., outside the United States, outside a jurisdiction of the regulatory authority) need not be reported in CTRs. On the other hand, client associated with certain business categories may not be eligible for exemption, irrespective of whether or not other criteria are satisfied.

Exemptions may be based on detailed manual review and risk assessments as may be performed by authorized employees of the financial institution. Manual processes associated with approving exemptions of transactions for filing CTRs may be error prone which may result in exemptions being wrongfully granted for transactions, or for exemptions not being granted for transactions that should be otherwise eligible.

As proposed herein, a dynamic CTR exemption system may be a self-evolving distributed hash chain-based utility supported by parallel processing quantum computing technology to identify potential transactions eligible for CTR filing or granting exemption. An inbuilt rules engine (e.g., which may be customizable) may be leveraged by a quantum technology-based real-time transaction analyzer to categorize transactions for identifying transactions for CTR filings/exemptions. The transaction analyzer, supported by quantum gates, may track transactions in real-time to identify any spikes in superposition of states as represented by a plurality of qubits (e.g., using Grover's algorithm). Transactions corresponding to these spikes are logged in a distributed hash chain-based ledger (e.g., as stored in a peer-to-peer, P2P, network). If the transaction is validated for CTR filing (e.g., by the transaction analyzer) a notification may be sent to a relevant team for processing the CTR filing. If the transaction is determined to valid for an exemption request, an authorization notification may be sent to relevant team (e.g., which may be associated with a node of the P2P network) with evidence to approve or reject the exemption.

Various example systems, methods, and devices described herein may enable streamlined parallel processing of large quantities of transactions for verification against existing CTR exemption rules. The parallel processing may be facilitated by quantum transaction analyzer which may simultaneously process a large number of transactions using the inherent properties relating to superposition of qubit states. This may further be supported by a distributed hash table (DHT) as maintained by a P2P network for enhanced security. The DHT hash table may be maintained by a plurality of computing nodes forming a P2P network. Each of the nodes of the P2P network may have a corresponding local hash chain (also called “source chain”) with data that may be only accessible to that node and its corresponding neighboring nodes. The distributed nature of the hash chains may ensure that no single node has access to the entirety of data as provided by the quantum transaction analyzer which may enhance data security.

In accordance with the above, a system for identifying and reporting financial transactions eligible for filing currency transaction reports (CTRs) is described. The system may comprise a plurality of computing nodes forming a hash chain network storing a distributed hash table (DHT); and a quantum computing platform. The quantum computing platform may receive (e.g., from existing banking infrastructure) indications of a plurality of transactions, wherein each of the indications comprise a corresponding transaction identifier. The quantum computing platform may initialize a plurality of qubits for representing transaction identifiers associated with the plurality of transactions, and apply Hadamard gates to the plurality of qubits to generate a uniform superposition of states. By properties associated with quantum superposition, each state corresponding to the uniform superposition may have an identical probability of occurrence and each state corresponding to the uniform superposition may represent a corresponding transaction identifier. The quantum computing platform may determine, using Grover's algorithm, one or more transaction identifiers of one or more transactions for which CTRs need not be filed (e.g., the one or more transactions that may be exempt from CTR filing). The determining the one or more transaction identifiers may be based on conformity of the one or more transactions to CTR exemption rules defined by a rule engine. The quantum computing platform may send, to the DHT, indications of the one or more transactions. Sending the indications of the one or more transactions to the DHT may comprise sending the indications to a subset of the plurality of computing nodes.

A computing node of the subset may receive indications of the one or more transactions and information associated with the one or more transactions. The computing node may add, to a local hash chain associated with the computing node, the indications of the one or more transactions and the information associated with the one or more transactions. The computing node may determine, using local CTR exemption rules associated with the computing node, at least one transaction, of the one or more transactions, for which CTRs are to be filed. The computing node may send, to a user computing device, a notification indicating the at least one transaction, and receive a user input indicating whether a CTR is to be filed for the at least one transaction. The computing node may update, based on the user input, the local hash chain to mark the at least one transaction for CTR filing or CTR exemption.

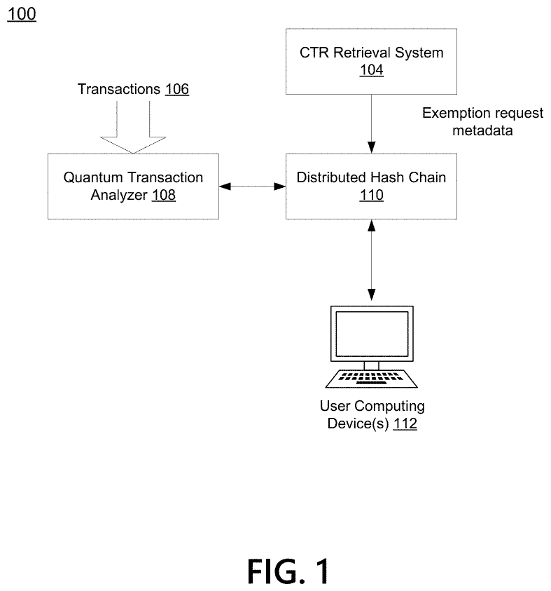

FIG. 1 shows an example architecture for a system to determine and process a CTR exemption for a transaction. The system 100 may comprise a quantum transaction analyzer 108, a distributed hash chain 110 (e.g., corresponding to a DHT, as stored by a plurality of computing nodes in a P2P network), and a CTR retrieval system 104. The system 100 may correspond to a banking/financial institution that is obligated to file CTRs or exempt CTR filings for transactions processed by the banking/financial institution.

As further described herein, incoming transactions 106 may be processed by the quantum transaction analyzer 108 to determine/recommend transactions which may quality for CTR exemptions and transactions for which CTRs are to be filed. Indications of the incoming transactions 106, along with recommendations of whether or not CTRs are to be filed (as determined by the quantum transaction analyzer 108) may be sent to the distributed hash chain 110 for manual review/CTR filing. The distributed hash chain 110 (e.g., or the DHT corresponding to the distributed hash chain 110) may be queried by one or more user computing device(s) 112 of the computing nodes. The distributed hash chain 110 may comprise a plurality of local hash chains at stored at the different computing nodes. The CTR retrieval system 104 may query a database that stores prior CTRs to retrieve metadata associated with transactions for which CTRs were previously filed. The metadata may be sent, along with the recommendations, to assist users (e.g., corresponding to the computing nodes) to determine of whether or not CTRs are to filed for the transactions.

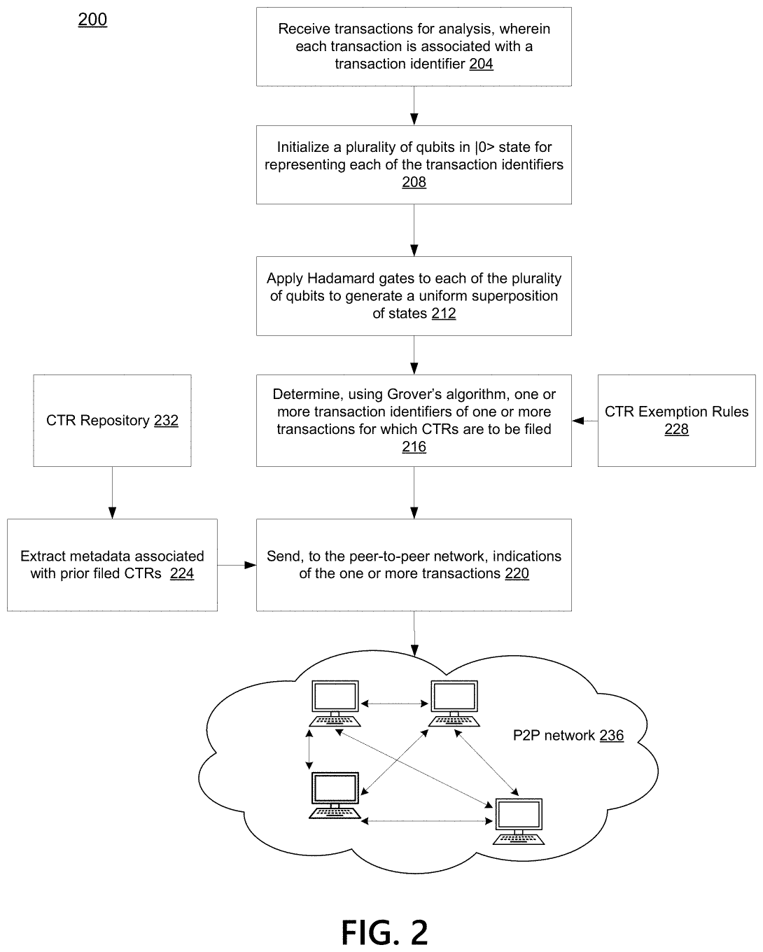

FIG. 2 shows an example algorithm 200 for determining whether or not a transaction is exempted from CTR filing. In an arrangement, the example algorithm 200 may be performed by the quantum transaction analyzer 108 as described with reference to FIG. 1. At step 204, the quantum transaction analyzer 108 may receive a plurality of transactions for analysis. The analysis may comprise determining whether or not one or more of the plurality of transactions is exempted from CTR filing. Each transaction may be associated with a transaction identifier and transaction information. The transaction information may comprise one or more of: monetary value of the transaction, source account of the transaction, destination account of the transaction, client name/business associated with the transaction, geographical location of the transaction, a business category of an entity associated with the transaction, a transaction type of the transaction, and/or the like. The geographical location may correspond to a physical address, Zip code, city, state, country, and/or the like, where the transaction was conducted

Transactions may include any of deposits and withdrawals to/from banking accounts, automated teller machine (ATM) transactions, denomination exchanges, loan payments, currency transactions used to fund individual retirement accounts (IRAs), purchases of certificates of deposit, funds transfers paid for in currency, monetary instrument purchases, and/or the like. Transactions may be processed at physical banking locations, merchant locations, ATMs, online portals, etc.

At step 208, the quantum transaction analyzer 108 may initiate a plurality of qubits in |0>state. The plurality of cubits may correspond to a quantum register for representing each of the transaction identifiers of the plurality of transactions. At step 212, Hadamard gates may be applied to each of the plurality of qubits to generate a uniform superposition of states. Each state corresponding to the uniform superposition represents a corresponding transaction identifier. Each state corresponding to the uniform superposition may also have an identical probability of occurrence. For example, if there are n qubits initialized for the quantum transaction analyzer, a total of N=2ⁿ states may be represented by the n qubits, and the quantum register, if read at this point in time, may indicate any one of the states with equal probabilities of 1/N. The uniform superposition may be expressed as:

$$\vert s 〉 = \frac{1}{\sqrt{N}} {\sum }_{x = 0}^{N - 1} \vert x 〉 \qquad Equation ( 1 )$$

where 1/N is a probability of each of states |x [symbol] .

At step 216, the quantum transaction analyzer 108 may apply the Grover's algorithm to determine one or more states, of the plurality of states, that may deviate from CTR exemption rules 228 as defined by a rule engine (also referred to herein as global CTR exemption rules). The one or more states so determined may correspond to one or more transaction identifiers of one or more transactions for which CTRs are to be filed. In other words, the one or more transaction identifiers may be based on deviations of the one or more transactions (e.g., deviation of transaction information associated with the one or more transactions) from the CTR exemption rules 228 defined by the rule engine. Transaction identifiers, corresponding to other states of the plurality of states, may correspond to transactions which may be exempt from CTR filing.

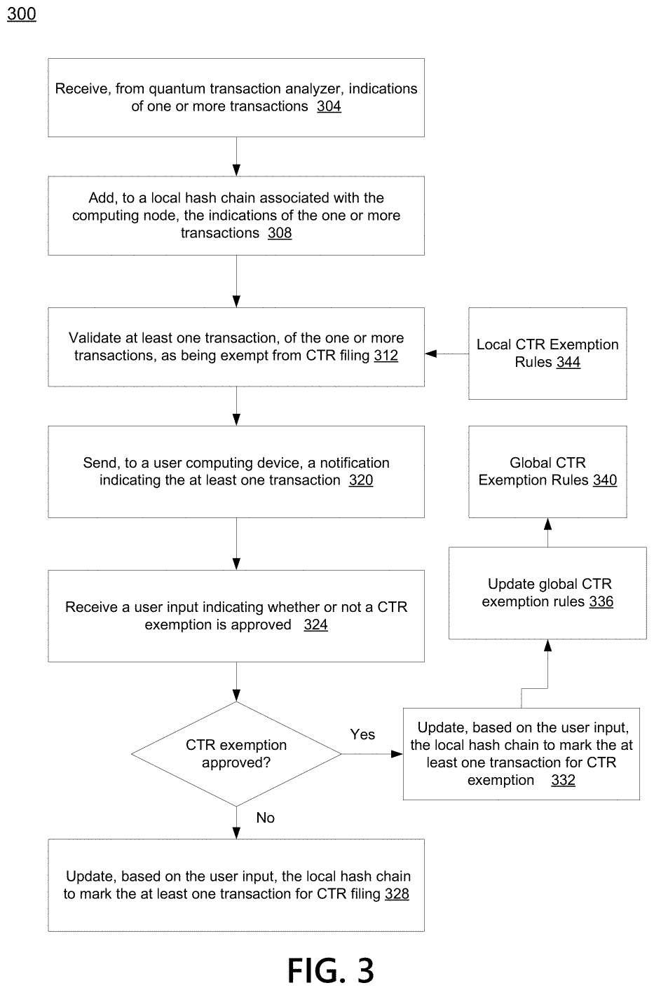

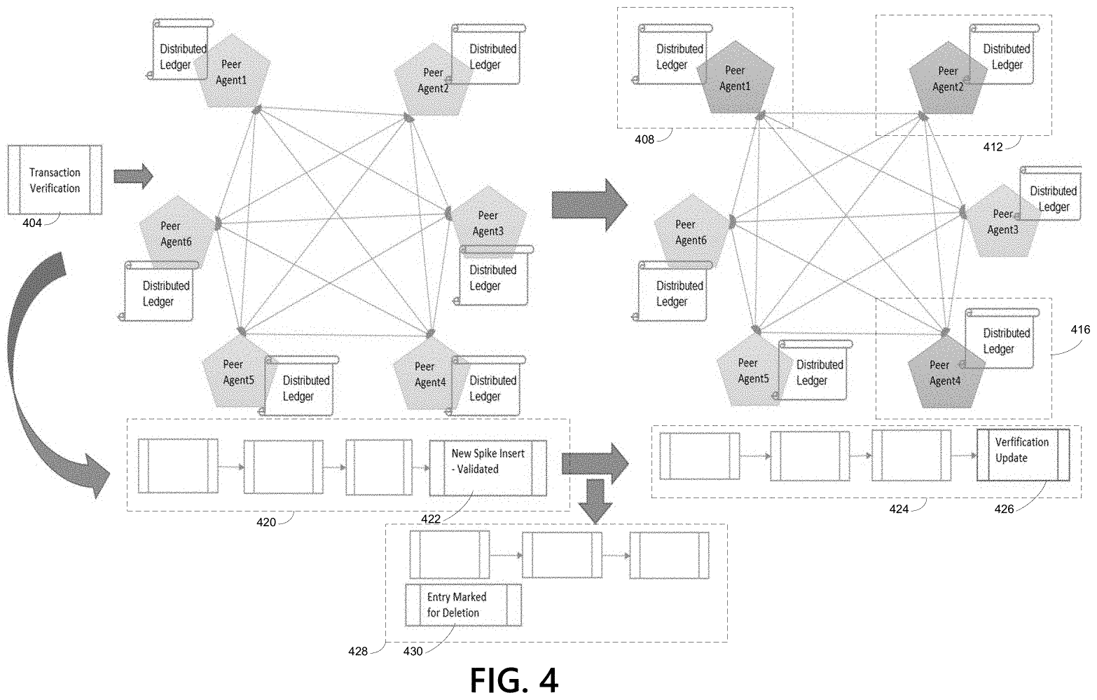

The CTR exemption rules may comprise user-defined rules and/or rules based on ledger entries as stored in the DHT. As further described herein, the DHT may store, in a P2P network, historical transactions for which CTR exemptions were previously approved. The CTR exemption rules may incorporate any transaction information (e.g., source account, destination account, entity name (e.g., client/business name), a business category of the entity, and/or the like) of a historical transaction for which a CTR exemption was previously approved. Further details associated with approving a CTR exemption and storing such information in the DHT are further described with respect to FIGS. 3 and 4.

CTR exemption may be based on one or more criteria as defined by the CTR exemption rules. The one or more criteria may be applied to transaction information associated with a transaction. For example, a CTR exemption may be based on monetary value of a transaction. A CTR exemption rule may define that a transaction may be exempted from CTR if monetary value of the transaction does not exceed a threshold monetary value as indicated in the rule engine. A CTR exemption may be based on a geographical location of a transaction. A CTR exemption rule may define that a transaction may be exempted from CTR if a geographical location of the transaction is not within a geographical limit or falls within a geographical limit as indicated in the rule engine. A CTR exemption may be based on a business category of an entity associated with a transaction. A CTR exemption rule may define that a transaction may be exempted from CTR only if a business category of the entity is not among a list of restricted entities as indicated in the rule engine. A CTR exemption may be based on a quantity of transactions historically conducted by an entity performing a current transaction. A CTR exemption rule may define that a current transaction may be exempted from CTR if an entity associated with a transaction has conducted more than a threshold quantity of transactions (e.g., exceeding a threshold monetary value) within a fixed prior time period as indicated in the rule engine.

Applying the Grover's algorithm may comprise applying an oracle to flip phases associated with the one or more states, corresponding to the one or more transaction identifiers, of the uniform superposition. The oracle is also referred to herein as a phase flip transaction scanner U_{ω}. The phase flip transaction scanner may be applied to uniform superposition |s [symbol] :

U_{ω}|s [symbol] =(−1)^{ƒ(x)}|x [symbol] Equation (2)

ƒ(x) may be based on CTR exemption rules 228 such that ƒ(x)=1 if the state |x [symbol] corresponds to a transaction identifier of a transaction for which a CTR is to be filed (e.g., because the transaction does not quality for an exemption as per the CTR exemption rules 228), and ƒ(x)=0 if the state |x [symbol] corresponds to a transaction identifier of a transaction for which a CTR is not to be filed (e.g., because the transaction qualities for an exemption as per the CTR exemption rules 228).

Applying the Grover's algorithm may further comprise determining a reflection of amplitudes of the one or more states (whose phases were flipped) along a mean amplitude of the plurality of the states. This process is known as amplitude amplification which enables the probability of measuring the one or more states (from the qubit register) to be boosted and the probabilities of other states to be suppressed. The amplitude of the one or more states, following the amplitude amplification, correspond to “spikes” which are then reflected during the measurement of the plurality of qubits. Applying the Grover's algorithm may comprise applying the phase flip transaction scanner and the reflection one or more times. Applying the Grover's algorithm may further comprise measuring the plurality of qubits to determine the one or more transaction identifiers corresponding to the one or more states. Since the probability of the one or more states is boosted by application of the phase flip transaction scanner and performing the reflection process, it is more probable that measurement of the plurality of qubits results in the measurement of the one or more states, rather than measurement of other states in the superposition of Equation (1). Thus, the one or more states may correspond to transaction identifiers of transactions for which CTR are recommended, and the other states may correspond to transaction identifiers of transactions that recommended to be exempt from CTR.

At step 220, the quantum transaction analyzer 108 may send to a P2P network 236 (e.g., storing the DHT in the form of a distributed hash chain) indications of the one or more transactions. Sending, to the P2P network 236, the indications of the one or more transaction may comprise sending the one or more transaction identifiers and transaction information associated with the one or more transactions. In an arrangement, the quantum transaction analyzer 108 may send to the P2P network 236 indications of the plurality of transactions. Sending, to the P2P network 236, the indications of the plurality of transaction may comprise sending transaction identifiers and/or transaction information corresponding to the plurality of transactions. The quantum transaction analyzer 108 may mark/indicate that the one or more transactions, of the plurality of transactions, correspond to transactions for which CTRs are recommended to be filed, and further mark/indicate that the other transactions, of the plurality of transactions, correspond to transactions which may be exempt from CTR filing. The indications of the one or more transactions may be sent to one or more nodes responsible for CTR filing. The indications of the one or more other transactions may be sent to one or more second nodes, different from the one or more first nodes, for manual review of the CTR exemption. Sending the indications of the one or more transactions or the plurality of transactions may comprise hashing corresponding transaction information and transaction identifiers of transactions.

Sending the indications of the one or more transactions or the plurality of transactions may further comprise sending metadata associated with prior filed CTRs. For example, the quantum transaction analyzer 108 may determine (e.g., step 224) entities, source/destination accounts, monetary values, locations, and/or the like, associated with prior transactions for which CTRs were filed. Information corresponding to the prior transactions may be stored in the CTR repository 232. The metadata may be sent, along with the indications of the one or more/plurality of transactions, to the P2P network 236. Employees of the financial/banking institution may review the transaction information of the one or more transactions and the metadata to file CTRs for the one or more transactions. Employees of the financial/banking institution may review the transaction information of one or more other transactions, that may be exempt from CTR filing, to approve or deny CTR exemptions. For example, the employees may access the transaction information via computing devices associated with a node of the P2P network 236. Further details with respect to this manual review of transactions is described with reference to FIG. 3.

The quantum transaction analyzer 108 may send an indication of a transaction to a subset of nodes (but not all nodes) of the P2P network 236 based on transaction information of the transaction. For example, the quantum transaction analyzer 108 may send an indication of a transaction to a first subset of nodes based on the transaction corresponding to a deposit via an ATM. The quantum transaction analyzer 108 may send an indication of a transaction to a second subset of nodes based on the transaction corresponding to an entity associated with a specific business category. The quantum transaction analyzer 108 may send an indication of a transaction to a third subset of nodes based on the transaction being made in a specific geographical location. Sending indications of transactions to only a subset of the nodes of the P2P network 236 may ensure that no node comprises information associated with all transactions processed by the quantum transaction analyzer 108. This improves overall security such that even if a node is compromised by an attacker, the attacker does not have access to information associated with all transactions processed by the quantum transaction analyzer 108.

FIG. 3 shows an example algorithm 300 at a computing node for processing a transaction as received from a quantum transaction analyzer. The computing node may be one of a plurality of computing nodes in the P2P network 236. The computing node may store a portion of the DHT (e.g., in a local hash chain). The DHT may store transaction identifiers and corresponding transaction information as received from the quantum transaction analyzer 108. The DHT may further store indications of whether or not corresponding transactions are determined to be exempt from CTR or correspond to transactions for which CTRs are to be filed. The example algorithm 300 may be applied to transactions that are determined/recommended, by the quantum transaction analyzer 108, as being exempt from CTR filing.

At step 304, the computing node may receive, from the quantum transaction analyzer 108, indications of one or more transactions. Receiving the indications of the one or more transactions may comprise receiving transaction identifiers associated with the one or more transactions and transaction information associated with the one or more transactions. The one or more transactions may correspond to transactions as determined, by the quantum transaction analyzer 108, as being exempt from CTR filing (e.g., at step 216). Receiving the indications of the one or more transactions may comprise receiving hashed transaction identifiers and transaction information. The computing node may further receive, from the quantum transaction analyzer 108, the metadata as determined/sent by the quantum transaction analyzer (e.g., at step 220).

At step 308, the computing node may add, to a local hash chain, the indications of the one or more transactions. At step 312, the computing node may validate at least one transaction, of the one or more transactions, as being exempt from CTR filing. The validating the at least one transaction may be based on local CTR exemption rules 344 associated with the computing node. Validating the at least one transaction as being exempt from CTR filing may comprise determining that the at least one transaction is exempt from CTR filing. The additional layer of check using local CTR exemption rules 344 may enable a computing node to locally define additional rules based on which CTR may be exempted. If the computing node fails to validate the at least one transaction, the system may return an error and send a notification to an appropriate user.

In an arrangement, the local CTR exemption rules 344 may be different from rules stored in the rule engine (CTR exemption rules 228, also referred to herein as global CTR exemption rules) as used by the quantum transaction analyzer 108. The local CTR exemption rules 344 may be based on one or more criteria that may be applied to transaction information associated with a transaction. The local CTR exemption rules 344 may be applied to one or more of, for example, a monetary value of a transaction, a geographical location of the transaction, a business category of an entity associated with the transaction, a quantity of transactions historically conducted by an entity performing a current transaction, and/or the like. The local CTR exemption rules 344 may be defined in a manner similar to the CTR exemption rules 228 as described with respect to FIG. 2.

At step 320, the computing node may send, to a user computing device associated with the computing node, a notification indicating the at least one transaction for manual review/verification. The computing node may additionally send the metadata as determined/sent by the quantum transaction analyzer (e.g., at step 220). Users/employees associated with the user computing device may manually review the at least one transaction (along with the metadata) to determine whether or not the at least one transaction qualifies for CTR exemption.

At step 324, the computing node may receive, from the user computing device, a user input indicating whether or not a CTR exemption is approved for the at least one transaction. If the CTR exemption is not approved, indication of the at least one transaction may be sent to another computing node for processing the CTR filing. Further, at step 328, the local hash chain may be updated to mark the at least one transaction for CTR filing.

If the CTR exemption is approved, the local hash chain may be updated to mark the at least one transaction as being exempt from CTR filing (e.g., step 332). Based on marking the at least one transaction as being exempt from CTR filing, the global CTR exemption rules 340 may be updated to include one or more elements of the transaction information. For example, the global CTR exemption rules 340 may be updated to indicate one or more of a monetary value of the at least one transaction, an entity associated with the at least one transaction, a business category of the entity, a geographical location of the transaction, and/or the like. The global CTR exemption rules 340 may correspond to the CTR exemption rules 228 as used by the quantum transaction analyzer 108. In this manner, any manual approval of a CTR exemption is reflected in processing of future transactions by the quantum transaction analyzer 108.

FIG. 4 shows an example P2P network for transaction verification at a computing node. A transaction 404 may be determined by the quantum transaction analyzer 108 as being exempt from CTR filing and sent to a subset of a plurality of computing nodes (e.g., nodes 408, 412, and 416) forming the P2P network (e.g., as described with respect to FIG. 2). Each of the subset of computing nodes may add the transaction as an entry to respective local hash chains. As shown in FIG. 4, the respective local hash chains may correspond to respective to respective distributed ledgers stored at the respective computing nodes. Addition of the transaction to respective local hash chains may be reflected as an addition of an entry 422 to a distributed hash chain 420 (e.g., corresponding to the DHT) as stored in the plurality of computing nodes.

Based on manual review of the transactions at the subset of nodes, users associated with the subset of nodes may determine whether or not a CTR is to be filed for the transaction (e.g., step 324 of FIG. 3). If a CTR is not to be filed (e.g., transaction is exempt), the DHT may be updated to mark the transaction as “verified.” This may be reflected as a verified entry 426 in an updated distributed hash chain 424. The verified entry 426 may comprise an indicator of the received transaction with an additional indication that the transaction has been verified as being exempt for CTR filing. These verified transactions may be used to update the global CTR exemption rules which may then be used for processing future transactions (e.g., as described in step 324).

If a CTR is to be filed, the DHT may be updated to mark the transaction for deletion. This may be reflected as an entry 430 in an updated distributed hash chain 428. The entry 430 may be an indicator of the received transaction with an additional indication that the entry 422 corresponding to transaction is marked for deletion.

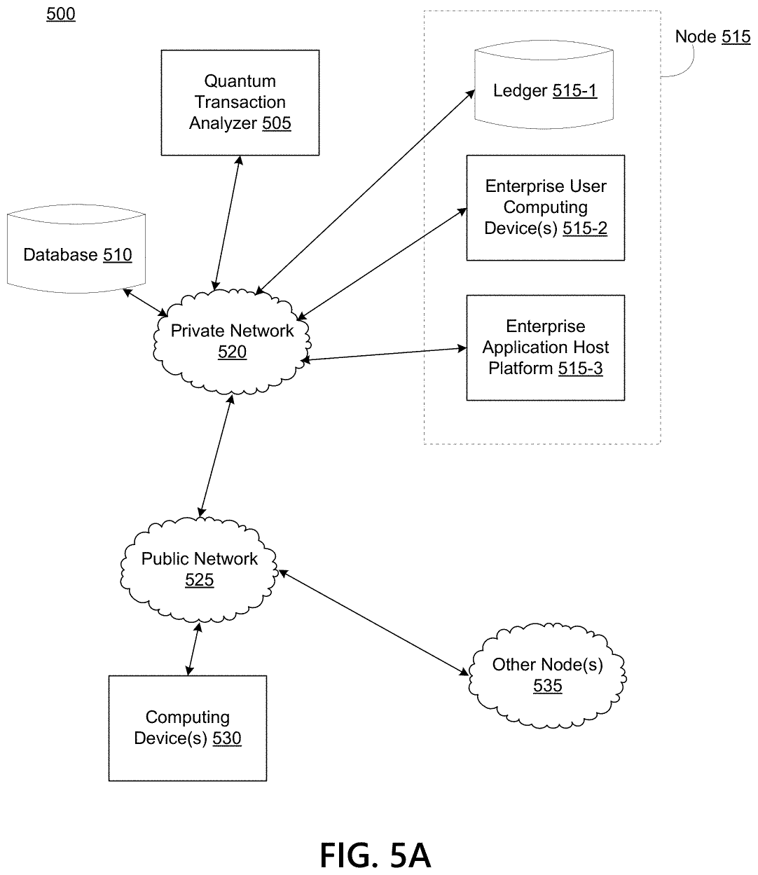

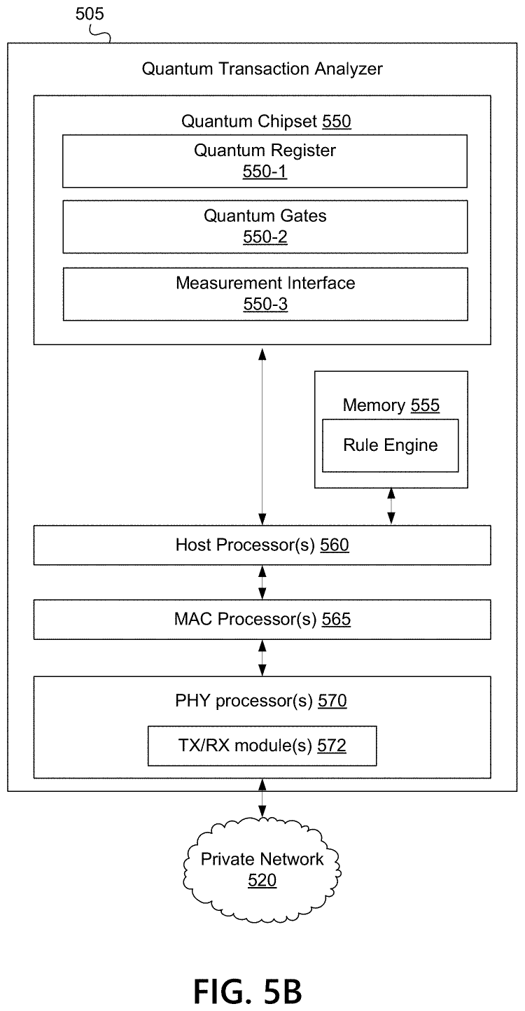

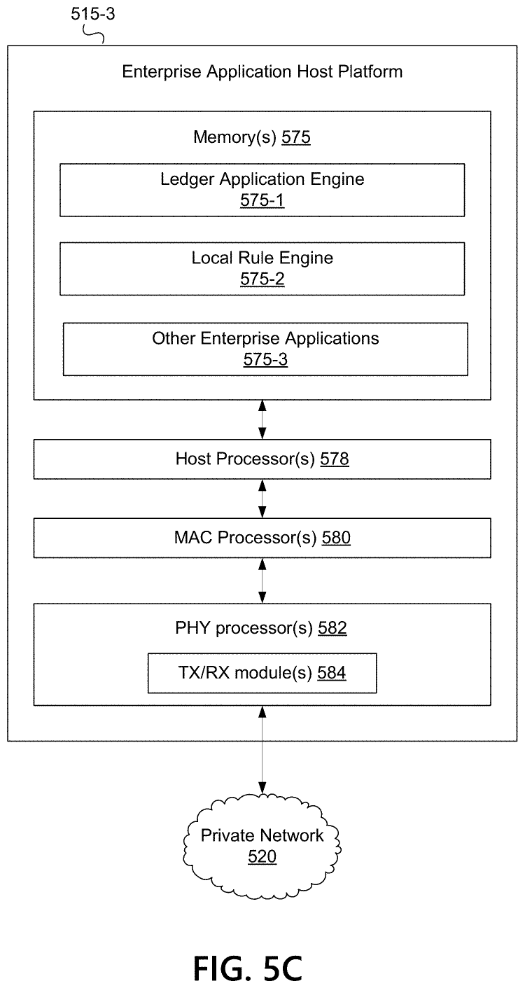

FIG. 5A shows an illustrative computing environment 500 for implementing a system for CTR exemption processing, in accordance with one or more arrangements. The computing environment 500 may comprise one or more devices (e.g., computer systems, communication devices, and the like). The one or more devices may be connected via one or more networks (e.g., a private network 520 and/or a public network 525). For example, the private network 520 may be associated with a financial organization processing client transactions. The computing environment 200 may comprise, for example, a quantum transaction analyzer 505, a database 510, and a computing node 515 connected via the private network 520. The node 515 may comprise a ledger 515-1, enterprise user computing device(s) 515-2, and/or an enterprise application host platform 515-3.

Device/systems within the private network 520 may be connected to other devices via a public network 525. For example, the public network 525 may connect one or more computing device 530 and one or more other computing nodes 535. The one or more other nodes 535 may have an architecture similar to node 515.

The devices in the computing environment 500 may transmit/exchange/share information via hardware and/or software interfaces using one or more communication protocols over the private network 520 and/or the public network 525. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3rd Generation Partnership Project (3GPP) cellular protocol, a hypertext transfer protocol (HTTP), and/or the like).

The quantum transaction analyzer 505 may comprise one or more computing devices and/or other computer components (e.g., processors, memories, communication interfaces) configured to perform one or more functions as described herein. Further details associated with the architecture of the quantum transaction analyzer 505 are described with reference to FIG. 5B.

The database 510 may store a CTR repository comprising information corresponding to prior CTR filings and exemptions. As described with respect to FIG. 2, the quantum transaction analyzer may extract metadata associated with the prior CTR filings and exemptions to enable manual review of incoming transactions.

The ledger 515-1 of node 515-1 may store a local hash chain for the node 515. Incoming transactions as provided by the quantum transaction analyzer may be stored in the ledger 515-1 for further processing (e.g., as described with respect to FIGS. 3 and 4).

The database 510 and/or the ledger 515-1 may comprise one or more servers or other computing devices that may be associated with computer storage media. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by the quantum transaction analyzer 505, the enterprise user computing device 515-2, and/or the enterprise application host platform 515-3.

The enterprise user computing device(s) 515-2 may be personal computing devices (e.g., desktop computers, laptop computers) or mobile computing devices (e.g., smartphones, tablets). In addition, the enterprise user computing device(s) 515-2 may be linked to and/or operated by specific enterprise users (who may, for example, be employees or other affiliates of the enterprise organization). An authorized user may use an enterprise user computing device 515-2 to manually review and approve/reject a transaction for CTR exemption (e.g., as described with respect to steps 320 and 324).

The enterprise application host platform 515 may comprise one or more computing devices and/or other computer components (e.g., processors, memories, communication interfaces). In addition, the enterprise application host platform 225 may be configured to host, execute, and/or otherwise provide one or more services/applications for the node 515. For example, the enterprise application host platform 515 may host applications for enabling a user (e.g., of the enterprise user computing device 515-2) to access/edit the ledger to manually approve/reject CTR exemptions. Further details associated with the enterprise application host platform are described with respect to FIG. 5C.

The other nodes 535 may have an architecture similar to the node 515. Corresponding ledgers of the different nodes may store respective local hash chains, which combine to form the distributed hash chain of the DHT. For example, the plurality of nodes may form a P2P network storing elements/entries of the DHT.

The computing device(s) 530 may be computing devices (e.g., desktop computers, laptop computers) or mobile computing devices (e.g., smartphones, tablets) that may be used to initiate transactions. In addition, the computing device(s) 530 may be linked to and/or operated by specific enterprise users (who may, for example, be employees or other affiliates of the enterprise organization) or clients associated with financial institution. The computing device(s) 530 may correspond to ATMs or banking computing systems that may be used to initiate transactions.

In one or more arrangements the quantum transaction analyzer 505, the database 510, the computing node 515, the ledger 515-1, the enterprise user computing device(s) 515-2, the enterprise application host platform 515-3, and/or the other devices/systems in the computing environment 500 may be any type of computing device capable of receiving input via a user interface, and communicating the received input to one or more other computing devices in the computing environment 500. For example, the quantum transaction analyzer 505, the database 510, the computing node 515, the ledger 515-1, the enterprise user computing device(s) 515-2, the enterprise application host platform 515-3, and/or the other devices/systems in the computing environment 500 may, in some instances, be and/or include server computers, desktop computers, laptop computers, tablet computers, smart phones, or the like that may comprised of one or more processors, memories, communication interfaces, storage devices, and/or other components. Any and/or all of the quantum transaction analyzer 505, the database 510, the computing node 515, the ledger 515-1, the enterprise user computing device(s) 515-2, the enterprise application host platform 515-3 and/or the other devices/systems in the computing environment 500 may, in some instances, be and/or comprise special-purpose computing devices configured to perform specific functions.

FIG. 5B shows an example quantum transaction analyzer 505, in accordance with one or more examples described herein. The quantum transaction analyzer 505 may comprise one or more of a quantum chipset 550, host processor(s) 560, medium access control (MAC) processor(s) 565, physical layer (PHY) processor(s) 570, transmit/receive (TX/RX) module(s) 572, memory 555, and/or the like. One or more data buses may interconnect the quantum chipset 550, host processor(s) 560, MAC processor(s) 565, PHY processor(s) 570, and/or Tx/Rx module(s) 572, and/or memory 555. The quantum transaction analyzer 505 may be implemented using one or more integrated circuits (ICs), software, or a combination thereof, configured to operate as discussed below. The quantum chipset 550, host processor(s) 560, the MAC processor(s) 565, and the PHY processor(s) 570 may be implemented, at least partially, on a single IC or multiple ICs. Memory 555 may be any memory such as a random-access memory (RAM), a read-only memory (ROM), a flash memory, or any other electronically readable memory, or the like.

Messages transmitted from and received at devices in the computing environment 500 may be encoded in one or more MAC data units and/or PHY data units. The MAC processor(s) 565 and/or the PHY processor(s) 570 of the quantum transaction analyzer 505 may be configured to generate data units, and process received data units, that conform to any suitable wired and/or wireless communication protocol. For example, the MAC processor(s) 565 may be configured to implement MAC layer functions, and the PHY processor(s) 570 may be configured to implement PHY layer functions corresponding to the communication protocol. The MAC processor(s) 565 may, for example, generate MAC data units (e.g., MAC protocol data units (MPDUs)), and forward the MAC data units to the PHY processor(s) 570. The PHY processor(s) 570 may, for example, generate PHY data units (e.g., PHY protocol data units (PPDUs)) based on the MAC data units. The generated PHY data units may be transmitted via the TX/RX module(s) 572 over the private network 520. Similarly, the PHY processor(s) 570 may receive PHY data units from the TX/RX module(s) 572, extract MAC data units encapsulated within the PHY data units, and forward the extracted MAC data units to the MAC processor(s). The MAC processor(s) 565 may then process the MAC data units as forwarded by the PHY processor(s) 570.

One or more processors (e.g., the host processor(s) 560, the MAC processor(s) 565, the PHY processor(s) 570, and/or the like) of the quantum transaction analyzer 505 may be configured to execute machine readable instructions stored in memory 555. The memory 555 may comprise one or more program modules/engines having instructions that when executed by the one or more processors cause the quantum transaction analyzer 505 to perform one or more functions described herein. The one or more program modules/engines and/or databases may be stored by and/or maintained in different memory units of the quantum transaction analyzer 505 and/or by different computing devices that may form and/or otherwise make up the quantum transaction analyzer 505. For example, the memory 555 may have, store, and/or comprise a rule engine (e.g., stored global CTR exemption rules) as used by the quantum chipset 550 to determine whether a transaction is eligible for CTR filing or exemption. The memory 555 may further comprise instructions that may be used by the quantum chipset 550 to perform various processing steps as described herein. For example, the memory 555 may store instructions that, when executed, cause the host processor to send instructions/data to the quantum chipset 550. The quantum chipset 550 may process data to generate an output, which may be retrieved by the host processor(s) 560.

The quantum chipset 550 may comprise a quantum register 550-1, quantum gates 550-2, and a measurement interface 550-3. The quantum register 550-1 may comprise a plurality of qubits as may be used to represent a superposition of states corresponding to a plurality of transaction identifiers. The quantum gates 550-2 may comprise gates used to perform processing on the plurality of qubits of the quantum register 550-1 in accordance with the various examples described herein. For example, the quantum gates 550-2 may implement the function f(x) based on the CTR exemption rules defined by the rule engine stored by the rule engine. The measurement interface 550-3 may interface the quantum chipset with other processors of the quantum transaction analyzer 505. For example, the measurement interface 550-3 may be used to read a current state of the quantum register to determine a transaction identifier as represented by the quantum register.

FIG. 5C shows an example enterprise application host platform 515-3, in accordance with one or more examples described herein. The enterprise application host platform 515-3 may comprise one or more of host processor(s) 578, MAC processor(s) 580, PHY processor(s) 582, TX/RX module(s) 584, memory 575, and/or the like. One or more data buses may interconnect the host processor(s) 578, MAC processor(s) 580, PHY processor(s) 582, and/or Tx/Rx module(s) 584, and/or memory 575. The enterprise application host platform 515-3 may be implemented using one or more ICs, software, or a combination thereof, configured to operate as discussed below. The host processor(s) 578, the MAC processor(s) 580, and the PHY processor(s) 582 may be implemented, at least partially, on a single IC or multiple ICs. Memory 575 may be any memory such as a RAM, a ROM, a flash memory, or any other electronically readable memory, or the like. The host processor(s) 578, MAC processor(s) 580, PHY processor(s) 582, and/or Tx/Rx module(s) 584 may operate in a manner similar to the host processor(s) 560, MAC processor(s) 565, PHY processor(s) 570, and/or Tx/Rx module(s) 572 as described with respect to FIG. 5B.

One or more processors (e.g., the host processor(s) 578, the MAC processor(s) 580, the PHY processor(s) 582, and/or the like) of the enterprise application host platform 515-3 may be configured to execute machine readable instructions stored in memory 575. The memory 575 may comprise one or more program modules/engines having instructions that when executed by the one or more processors cause the enterprise application host platform 515-3 to perform one or more functions described herein. The one or more program modules/engines and/or databases may be stored by and/or maintained in different memory units of the enterprise application host platform 515-3 and/or by different computing devices that may form and/or otherwise make up the enterprise application host platform 515-3. For example, the memory 575 may have, store, and/or comprise a local rule engine 575-2 storing local CTR exemption rules corresponding to the node 515. The memory 575 may further comprise a ledger application engine 575-1 that may be used by a user computing device (e.g., the enterprise user computing device 515-2) to access the local hash chain (e.g., ledger 515-1), corresponding to the node 515, for approving/rejecting CTR exemptions. The memory 575 may further comprise one or more other enterprise applications that may be used by one or more devices in the private network 520.

While FIG. 5A illustrates the quantum transaction analyzer 505, the database 510, the computing node 515, the ledger 515-1, the enterprise user computing device(s) 515-2, and the enterprise application host platform 515-3 as being separate elements connected in the private network 520, in one or more other arrangements, functions of one or more of the above may be integrated in a single device/network of devices. For example, elements in the quantum transaction analyzer 210 (e.g., host processor(s) 560, memory(s) 555, MAC processor(s) 565, PHY processor(s) 570, TX/RX module(s) 572, and/or one or more program/modules stored in memory(s) 555) may share hardware and software elements with and corresponding to, for example, the enterprise application host platform 515-1.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A system for identifying and reporting financial transactions eligible for filing currency transaction reports (CTRs), the system comprising:
a plurality of computing nodes forming a peer-to-peer network storing a distributed hash table (DHT); and
a quantum computing platform comprising:
a processor; and
memory storing computer-readable instructions that, when executed by the processor, cause the quantum computing platform to:
receive indications of a plurality of transactions, wherein each of the indications comprises a corresponding transaction identifier;
initialize a plurality of qubits for representing transaction identifiers associated with the plurality of transactions;
apply Hadamard gates to the plurality of qubits to generate a uniform superposition of states, wherein:
each state corresponding to the uniform superposition has an identical probability of occurrence; and
each state corresponding to the uniform superposition represents a corresponding transaction identifier;
determine, using Grover's algorithm, one or more transaction identifiers of one or more transactions for which CTRs are to be filed, wherein the determining the one or more transaction identifiers are based on deviations of the one or more transactions from CTR exemption rules defined by a rule engine; and
send, to the DHT, indications of the one or more transactions.

2. The system of claim 1, wherein the instructions, when executed by the processor, cause the quantum computing platform to:
generate, based on the rules defined by the rule engine, a phase flip transaction scanner to flip phases of one or more states, corresponding to the one or more transaction identifiers, of the uniform superposition.

3. The system of claim 2, wherein the instructions, when executed by the processor, cause the quantum computing platform to determine the one or more transaction identifiers by causing:
applying the phase flip transaction scanner to the uniform superposition to flip phases of the one or more states, corresponding to the one or more transaction identifiers, of the uniform superposition;
determining a reflection of amplitudes of the one or more states along a mean amplitude of the states; and
measuring the plurality of qubits to determine the one or more transaction identifiers corresponding to the one or more states.

4. The system of claim 1, wherein each transaction of the plurality of transactions is associated with corresponding transaction information, wherein transaction information of a transaction comprises one or more of:
monetary value of the transaction;
source account of the transaction;
destination account of the transaction;
geographical location of the transaction; or
business category of an entity associated with the transaction; and
wherein sending, to the DHT, indications of the one or more transactions comprises sending, to the DHT, the one or more transaction identifiers and transaction information of each of the one or more transactions.

5. The system of claim 4, wherein the rule engine comprises one or more of:
user-defined rules for CTR exemption; or
ledger entries, from the DHT, indicating historical transactions for which CTR exemptions were previously approved.

6. The system of claim 4, wherein the deviations of the one or more transactions from the CTR exemption rules defined by the rule engine comprises deviation of transaction information of the one or more transactions from the CTR exemption rules defined by the rule engine.

7. The system of claim 4, wherein the instructions, when executed by the processor, cause the quantum computing platform to determine the one or more transaction identifiers based on determining that corresponding monetary values of the one or more transactions exceeds a threshold monetary value as indicated in the rule engine.

8. The system of claim 4, wherein the instructions, when executed by the processor cause, the quantum computing platform to determine the one or more transaction identifiers based on determining that geographical locations associated with the one or more transactions is outside a geographical location as indicated in the rule engine.

9. The system of claim 1, wherein the instructions, when executed by the processor, cause the quantum computing platform to send, to the DHT, the indications of the one or more transactions by causing sending the indications of the one or more transactions to a subset of the plurality of computing nodes.

10. The system of claim 1, wherein the instructions, when executed by the processor, cause the quantum computing platform to send, to the DHT, the indications of the one or more transactions by causing sending, to the DHT, the indications of the one or more transactions along with indications that the quantum computing platform recommends CTR filing for the one or more transactions.

11. The system of claim 1, wherein a transaction of the plurality of transactions comprise:
deposits,
withdrawals,
automated teller machine (ATM) transactions,
denomination exchanges, or
electronic fund transfers paid for in currency.

12. A method for identifying and reporting financial transactions eligible for filing currency transaction reports (CTRs), the method comprising:
receiving indications of a plurality of transactions, wherein each of the indications comprises a corresponding transaction identifier;
initializing a plurality of qubits for representing transaction identifiers associated with the plurality of transactions;
applying Hadamard gates to the plurality of qubits to generate a uniform superposition of states, wherein:
each state corresponding to the uniform superposition has an identical probability of occurrence; and
each state corresponding to the uniform superposition represents a corresponding transaction identifier;
determining, using Grover's algorithm, one or more transaction identifiers of one or more transactions for which CTRs are to be filed, wherein the determining the one or more transaction identifiers are based on deviations of the one or more transactions from CTR exemption rules defined by a rule engine; and
sending, to a distributed hash table (DHT), indications of the one or more transactions, wherein the DHT is stored by a plurality of computing nodes forming a peer-to-peer network.

13. The method of claim 12, further comprising:
generating, based on the rules defined by the rule engine, a phase flip transaction scanner to flip phases of one or more states, corresponding to the one or more transaction identifiers, of the uniform superposition.

14. The method of claim 13, wherein the determining the one or more transaction identifiers comprises:
applying the phase flip transaction scanner to the uniform superposition to flip phases of the one or more states, corresponding to the one or more transaction identifiers, of the uniform superposition;
determining a reflection of amplitudes of the one or more states along a mean amplitude of the states; and
measuring the plurality of qubits to determine the one or more transaction identifiers corresponding to the one or more states.

15. The method of claim 12, wherein the sending, to the DHT, the indications of the one or more transactions comprises sending the indications of the one or more transactions to a subset of the plurality of computing nodes.

16. The method of claim 12, wherein each transaction of the plurality of transactions is associated with corresponding transaction information, wherein transaction information of a transaction comprises one or more of:
monetary value of the transaction;
source account of the transaction;
destination account of the transaction;
geographical location of the transaction; or
business category of an entity associated with the transaction; and
wherein sending, to the DHT, indications of the one or more transactions comprises sending, to the DHT, the one or more transaction identifiers and transaction information of each of the one or more transactions.

17. The method of claim 16, wherein the rule engine comprises one or more of:
user-defined rules for CTR exemption; or
ledger entries, from the DHT, indicating historical transactions for which CTR exemptions were previously approved.

18. The method of claim 16, wherein the deviations of the one or more transactions from the CTR exemption rules defined by the rule engine comprises deviation of transaction information of the one or more transactions from the CTR exemption rules defined by the rule engine.

19. The method of claim 16, wherein the determining the one or more transaction identifiers is based on determining that corresponding monetary values of the one or more transactions exceeds a threshold monetary value as indicated in the rule engine.

20. A non-transitory computer-readable medium storing computer-executable instructions that, when executed by a computer processor, causes a computing platform to:
receive indications of a plurality of transactions, wherein each of the indications comprises a corresponding transaction identifier;
initialize a plurality of qubits for representing transaction identifiers associated with the plurality of transactions;
apply Hadamard gates to the plurality of qubits to generate a uniform superposition of states, wherein:
each state corresponding to the uniform superposition has an identical probability of occurrence; and
each state corresponding to the uniform superposition represents a corresponding transaction identifier;
determine, using Grover's algorithm, one or more transaction identifiers of one or more transactions for which CTRs are to be filed, wherein the determining the one or more transaction identifiers are based on deviations of the one or more transactions from CTR exemption rules defined by a rule engine; and
send, to a distributed hash table (DHT), indications of the one or more transactions, wherein the DHT is stored by a plurality of computing nodes forming a peer-to-peer network.
